(19) United States
(12) Patent Application Publication
(10) Pub. No.: US 2026/0308368 A1
(43) Pub. Date: Oct. 8, 2026

(54) Polyolefin Resin Composition and Molded Article Produced Therefrom

(71) Applicant: LOTTE CHEMICAL CORPORATION, Seoul (KR)

(72) Inventors: Sang Hyun HONG, Uiwang-si (KR); Jae In KWON, Uiwang-si (KR); Joon Hee LEE, Uiwang-si (KR); Kyun Ha BAN, Uiwang-si (KR)

(21) Appl. No.: 19/481,646

(22) PCT Filed: May 14, 2024
(86) PCT No.: PCT/KR2024/006532

§ 371 Date: Nov. 5, 2025

(30) Foreign Application Priority Data
May 24, 2023 (KR) 10-2023-0067099

(51) Int. Cl. C08L 23/14

(52) U.S. Cl. CPC C08L 23/142; C08L 2205/025; C08L 2205/035; C08L 2207/066

(57) ABSTRACT

A polyolefin resin composition of the present invention comprises: about 100 parts by weight of a base material including about 60 wt % to about 98 wt % of a polypropylene copolymer resin, and about 1 wt % to about 30 wt % of a polyethylene resin, and about 1 wt % to about 30 wt % of a polyolefin-based elastomer; and about 3 parts by weight to about 15 parts by weight of a maleic anhydride-modified polypropylene resin including about 50 wt % to about 95 wt % of a first maleic anhydride-modified polypropylene having a weight average molecular weight of about 40,000 g/mol or more and a maleic anhydride modification ratio of about 1.5 wt % or more, and about 5 wt % to about 50 wt % of a second maleic anhydride-modified polypropylene having a weight average molecular weight of less than about 40,000 g/mol and a maleic anhydride modification ratio of about 1.5 wt % or more. The polyolefin resin composition has excellent adhesive strength in terms of adhering to a polar substrate, electrolyte resistance, and the like.

### TECHNICAL FIELD

The present invention relates to a polyolefin resin composition and a molded article produced therefrom. More particularly, the present invention relates to a polyolefin resin composition having good properties in terms of adhesive strength to polar substrates, electrolyte resistance, and the like, and a molded article produced therefrom.

### BACKGROUND ART

Among polyolefin resins, polypropylene resins exhibit good properties in terms of rigidity, transparency, heat resistance, and the like, and have been widely used as a thermoplastic molding material. As a non-polar resin, polypropylene resins are required to be modified with acid to achieve adhesion to polar substrates. In addition, since insufficient adhesion of a polypropylene resin is generally due to poor properties thereof in terms of flexibility and wettability, an elastomer component is commonly blended with the polypropylene resin to enhance adhesive performance to polar materials.

Although blending an elastomer component with an acid-modified polypropylene resin can improve room-temperature adhesion, there still exists the problem that such a blend can suffer from deterioration in adhesive strength when soaked in a battery electrolyte or the like and then left at a temperature of 80° C. or higher.

Therefore, there is a need for a polyolefin-based resin composition that exhibits good properties in terms of adhesive strength to polar substrates, electrolyte resistance, and the like.

The background technique of the invention is disclosed in Korean Patent Registration No. 10-1200658 and the like.

### DISCLOSURE

### Technical Problem

It is an object of the present invention to provide a polyolefin resin composition having good properties in terms of adhesive strength to polar substrates, electrolyte resistance, and the like.

It is another object of the present invention to provide a molded article formed of the polyolefin resin composition set forth above.

The above and other objects of the present invention will become apparent from the detailed description of the following embodiments.

### Technical Solution

1. One aspect of the present invention relates to a polyolefin resin composition. The polyolefin resin composition comprises: about 100 parts by weight of a base material comprising about 60 wt % to about 98 wt % of a polypropylene copolymer resin, about 1 wt % to about 30 wt % of a polyethylene resin, and about 1 wt % to about 30 wt % of a polyolefin elastomer; and about 3 parts by weight to about 15 parts by weight of a maleic anhydride-modified polypropylene resin comprising about 50 wt % to about 95 wt % of a first maleic anhydride-modified polypropylene having a weight average molecular weight of about 40,000 g/mol or more and a maleic anhydride graft ratio of about 1.5 wt % or more and about 5 wt % to about 50 wt % of a second maleic anhydride-modified polypropylene having a weight average molecular weight of less than about 40,000 g/mol and a maleic anhydride graft ratio of about 1.5 wt % or more.

2. In embodiment 1, the polypropylene copolymer resin may comprise at least one of a propylene/ethylene random copolymer and a propylene/ethylene/α-olefin copolymer.

3. In embodiment 1 or 2, the polypropylene copolymer resin may comprise about 85 mol % to about 99 mol % of a propylene-derived component, about 1 mol % to about 10 mol % of an ethylene-derived component, and about 0 mol % to about 8 mol % of an α-olefin-derived component.

4. In embodiments 1 to 3, the polypropylene copolymer resin may have a melting point (Tm) of about 120° C. to about 150° C.

5. In embodiments 1 to 4, the polyethylene resin may comprise at least one of low-density polyethylene (LDPE), medium-density polyethylene (MDPE), high-density polyethylene (HDPE), and linear low-density polyethylene (LLDPE).

6. In embodiments 1 to 5, the polyethylene resin may comprise at least one of low-density polyethylene (LDPE) and linear low-density polyethylene (LLDPE).

7. In embodiments 1 to 6, the polyolefin elastomer may comprise at least one of ethylene-propylene rubber, ethylene-butene rubber, and ethylene-octene rubber.

8. In embodiments 1 to 7, the first maleic anhydride-modified polypropylene may have a weight average molecular weight of about 45,000 g/mol to about 60,000 g/mol and a maleic anhydride graft ratio of about 1.6 wt % to about 6 wt %.

9. In embodiments 1 to 8, the second maleic anhydride-modified polypropylene may have a weight average molecular weight of about 10,000 g/mol to about 39,000 g/mol and a maleic anhydride graft ratio of about 1.6 wt % to about 6 wt %.

10. In embodiments 1 to 9, a weight ratio of the first maleic anhydride-modified polypropylene to the second maleic anhydride-modified polypropylene may range from about 1:0.06 to about 1:0.7.

11. In embodiments 1 to 10, the polyolefin resin composition may have an adhesive strength of about 15 kgf/cm² to about 20 kgf/cm², as measured on a specimen through a procedure, in which the specimen is prepared by forming a bilayer film composed of a layer of the polyolefin resin composition and a layer of a polypropylene resin using a multilayer film forming machine, and attaching the bilayer film to a nylon-attached aluminum film with the layer of the polyolefin resin composition adjoining the aluminum film, followed by heating to 200° C. for 5 minutes, and in which measurement of the adhesive strength is performed by cutting the specimen to a size of 100 mm length, 15 mm width and peeling the layer of the polypropylene resin off of the aluminum film at a rate of 50 mm/min using a universal testing machine (UTM).

12. In embodiments 1 to 11, the polyolefin resin composition may have an adhesive strength of about 8 kgf/cm² to about 15 kgf/cm², as measured on a specimen through a procedure, in which the specimen is prepared by forming a bilayer film composed of a layer of the polyolefin resin composition and a layer of a polypropylene resin using a multilayer film forming machine, and attaching the bilayer film to a nylon-attached aluminum film with the layer of the polyolefin resin composition adjoining the aluminum film, followed by heating to 200° C. for 5 minutes, and in which measurement of the adhesive strength is performed by cutting the specimen to a size of 100 mm length, 25 mm width, dipping the specimen in an electrolyte for lithium secondary batteries at 85° C. for 24 hours, cutting both sides of the specimen to prepare a test piece having a length of 100 mm and a width of 15 mm, and peeling the layer of the polypropylene resin off of the aluminum film at a rate of 50 mm/min using a universal testing machine (UTM).

13. Another aspect of the present invention relates to a molded article. The molded article is formed of the polyolefin resin composition according to any one of embodiments 1 to 12.

### Advantageous Effects

Embodiments of the present invention provide a polyolefin resin composition having good properties in terms of adhesive strength to polar substrates, electrolyte resistance, and the like, and a molded article formed of the same.

### BEST MODE

Hereinafter, exemplary embodiments of the present invention will be described in detail.

A polyolefin resin composition according to the present invention comprises: (A) a base material comprising a polypropylene copolymer resin, a polyethylene resin, and a polyolefin elastomer; and (B) a maleic anhydride-modified polypropylene resin comprising a first maleic anhydride-modified polypropylene and a second maleic anhydride-modified polypropylene.

As used herein to represent a specific numerical range, “a to b” means “a≤ and ≤b”.

### (A) Base Material

The base material according to one embodiment of the invention comprises a polypropylene copolymer resin, a polyethylene resin, and a polyolefin elastomer and serves to improve properties of the polyolefin resin composition, such as adhesive strength to polar substrates, electrolyte resistance, and the like, in combination with the maleic anhydride-modified polypropylene resin comprising a first maleic anhydride-modified polypropylene and a second maleic anhydride-modified polypropylene each having specific ranges of weight average molecular weight and maleic anhydride graft ratio.

In some embodiments, the polypropylene copolymer resin may comprise at least one of a propylene/ethylene random copolymer and a propylene/ethylene/α-olefin copolymer.

In some embodiments, the polypropylene copolymer resin may comprise about 85 mol % to about 99 mol %, for example, about 90 mol % to about 98 mol %, of a propylene-derived component, about 1 mol % to about 10 mol %, for example, about 2 mol % to about 5 mol %, of an ethylene-derived component, and about 0 mol % to about 8 mol %, for example, about 0 mol % to about 5 mol %, of an α-olefin-derived component. Here, when the content of the α-olefin-derived component is 0 mol %, the polypropylene copolymer resin is a propylene/ethylene random copolymer. Within these ranges, the polyolefin resin composition can have good properties in terms of processability, film formability, and the like.

In some embodiments, the polypropylene copolymer resin may have a melting point (Tm) of about 120° C. to about 150° C., for example, about 125° C. to about 145° C. Within this range, the polyolefin resin composition can have good properties in terms of adhesion (adhesive strength to polar substrates), and the like.

In some embodiments, the polypropylene copolymer resin may be present in an amount of about 60 wt % to about 98 wt %, for example, about 65 wt % to about 90 wt %, for example, about 75 wt % to about 85 wt %, based on the total weight of the base material. If the content of the polypropylene copolymer resin falls outside this range, the polyolefin resin composition can have poor properties in terms of mechanical performance, processability, and the like.

In some embodiments, the polyethylene resin may comprise at least one of low-density polyethylene (LDPE), medium-density polyethylene (MDPE), high-density polyethylene (HDPE), and linear low-density polyethylene (LLDPE). For example, the polyethylene resin may comprise low-density polyethylene (LDPE) and/or linear low-density polyethylene (LLDPE).

In some embodiments, the polyethylene resin may have a melt-flow index (MFI) of about 0.5 g/10 min to about 15 g/10 min, for example, about 1 g/10 min to about 10 g/10 min, as measured at a temperature of 190° C. under a load of 2.16 kg in accordance with ASTM D1238. Within this range, the polyolefin resin composition can have good properties in terms of film formability and the like.

In some embodiments, the polyethylene resin may be present in an amount of about 1 wt % to about 30 wt %, for example, about 5 wt % to about 25 wt %, for example, about 5 wt % to about 10 wt %, based on the total weight of the base material. If the content of the polyethylene resin falls outside this range, the polyolefin resin composition can have poor properties in terms of mechanical performance, processability, and the like.

In some embodiments, the polyolefin elastomer serves to improve adhesive strength to polar substrates, electrolyte resistance, and the like, and may include a polyolefin elastomer used in typical polyolefin resin compositions.

In some embodiments, the polyolefin elastomer may include ethylene-propylene rubber, ethylene-butene rubber, ethylene-octene rubber, and combinations thereof, for example, ethylene-propylene rubber.

In some embodiments, the polyolefin elastomer may have a melt-flow index (MFI) of about 0.1 g/10 min to about 5 g/10 min, for example, about 0.5 to about 3 g/10 min, as measured at a temperature of 190° C. under a load of 2.16 kg in accordance with ASTM D1238. Within this range, the polyolefin resin composition may have good properties in terms of wettability, mechanical performance, and the like.

In some embodiments, the polyolefin elastomer may be present in an amount of about 1 wt % to about 30 wt %, for example, about 5 wt % to about 25 wt %, for example, about 10 wt % to about 15 wt %, based on the total weight of the base material. If the content of the polyolefin elastomer falls outside this range, the polyolefin resin composition can have poor properties in terms of adhesive strength to polar substrates, electrolyte resistance, and the like.

### (B) Maleic Anhydride-Modified Polypropylene Resin

The maleic anhydride-modified polypropylene resin according to one embodiment of the invention comprises a first maleic anhydride-modified polypropylene and a second maleic anhydride-modified polypropylene each having specific ranges of weight average molecular weight and maleic anhydride graft ratio and serves to improve properties of the polyolefin resin composition, such as adhesive strength to polar substrates, electrolyte resistance, and the like, in combination with the base material.

In some embodiments, the first maleic anhydride-modified polypropylene may include a maleic anhydride-modified polypropylene having a weight average molecular weight of about 40,000 g/mol or more and a maleic anhydride graft ratio of about 1.5 wt % or more.

In some embodiments, the first maleic anhydride-modified polypropylene may have a weight average molecular weight of about 40,000 g/mol or more, for example, about 45,000 g/mol to about 60,000 g/mol, as measured by gel permeation chromatography (GPC). If the weight average molecular weight of the first maleic anhydride-modified polypropylene is less than about 40,000 g/mol, the polyolefin resin composition can have poor properties in terms of adhesive strength to polar substrates, electrolyte resistance, and the like.

In some embodiments, the first maleic anhydride-modified polypropylene may have a maleic anhydride graft ratio of about 1.5 wt % or more, for example, about 1.6 wt % to about 6 wt %, for example, about 1.7 wt % to about 3 wt %. If the maleic anhydride graft ratio of the first maleic anhydride-modified polypropylene is less than about 1.5 wt %, the polyolefin resin composition can have poor properties in terms of adhesive strength to polar substrates, electrolyte resistance, and the like.

In some embodiments, the first maleic anhydride-modified polypropylene may be present in an amount of about 50 wt % to about 95 wt %, for example, about 65 wt % to about 94 wt %, based on the total weight of the maleic anhydride-modified polypropylene resin. If the content of the first maleic anhydride-modified polypropylene falls outside this range, the polyolefin resin composition can have poor properties in terms of adhesive strength to polar substrates, electrolyte resistance, and the like.

In some embodiments, the second maleic anhydride-modified polypropylene may include a maleic anhydride-modified polypropylene having a weight average molecular weight of less than about 40,000 g/mol and a maleic anhydride graft ratio of about 1.5 wt % or more.

In some embodiments, the second maleic anhydride-modified polypropylene may have a weight average molecular weight of less than about 40,000 g/mol, for example, about 10,000 g/mol to about 39,000 g/mol, as measured by gel permeation chromatography (GPC). If the weight average molecular weight of the second maleic anhydride-modified polypropylene is about 40,000 g/mol or more, the polyolefin resin composition can have poor properties in terms of adhesive strength to polar substrates, electrolyte resistance, and the like.

In some embodiments, the second maleic anhydride-modified polypropylene may have a maleic anhydride graft ratio of about 1.5 wt % or more, for example, about 1.6 wt % to about 6 wt %, for example, about 2.5 wt % to about 4.5 wt %. If the maleic anhydride graft ratio of the second maleic anhydride-modified polypropylene is less than about 1.5 wt %, the polyolefin resin composition can have poor properties in terms of adhesive strength to polar substrates, electrolyte resistance, and the like.

In some embodiments, the second maleic anhydride-modified polypropylene may be present in an amount of about 5 wt % to about 50 wt %, for example, about 6 wt % to about 35 wt %, based on the total weight of the maleic anhydride-modified polypropylene resin. If the content of the second maleic anhydride-modified polypropylene falls outside this range, the polyolefin resin composition can have poor properties in terms of adhesive strength to polar substrates, electrolyte resistance, and the like.

In some embodiments, a weight ratio of the first maleic anhydride-modified polypropylene to the second maleic anhydride-modified polypropylene (first maleic anhydride-modified polypropylene:second maleic anhydride-modified polypropylene) may range from about 1:0.06 to about 1:0.7, for example, about 1:0.07 to about 1:0.6. Within this range, the polyolefin resin composition can have further improved properties in terms of adhesive strength to polar substrates, electrolyte resistance, and the like.

In some embodiments, the maleic anhydride-modified polypropylene resin may be present in an amount of about 3 parts by weight to about 15 parts by weight, for example, about 5 parts by weight to about 10 parts by weight, for example, about 5.5 parts by weight to about 7.5 parts by weight, relative to 100 parts by weight of the base material. If the content of the maleic anhydride-modified polypropylene resin falls outside this range, the polyolefin resin composition can have poor properties in terms of adhesive strength to polar substrates, electrolyte resistance, and the like.

The polyolefin resin composition according to one embodiment of the invention may further include additives used in typical polyolefin resin compositions. Examples of the additives may include antioxidants, stabilizers, flame retardants, anti-dripping agents, lubricants, release agents, nucleating agents, antistatic agents, pigments, dyes, and mixtures thereof, without being limited thereto. When the additives are used, the additives may be present in an amount of about 0.001 parts by weight to about 20 parts by weight, for example, about 0.1 parts by weight to about 10 parts by weight, relative to 100 parts by weight of the base material, without being limited thereto.

The polyolefin resin composition according to one embodiment of the invention may be prepared in pellet form by mixing the aforementioned components, followed by melt extrusion in a typical twin-screw extruder at a temperature of about 150° C. to about 230° C., for example, about 170° C. to about 210° C.

In some embodiments, the polyolefin resin composition may have an adhesive strength of about 15 kgf/cm² to about 20 kgf/cm², for example, about 15 kgf/cm² to about 19 kgf/cm², as measured on a specimen through a procedure, in which the specimen is prepared by forming a bilayer film composed of a layer of the polyolefin resin composition and a layer of a polypropylene resin using a multilayer film forming machine, and attaching the bilayer film to a nylon-attached aluminum film with the layer of the polyolefin resin composition adjoining the aluminum film, followed by heating to 200° C. for 5 minutes, and in which measurement of the adhesive strength is performed by cutting the specimen to a size of 100 mm length, 15 mm width and peeling the layer of the polypropylene resin off of the aluminum film at a rate of 50 mm/min using a universal testing machine (UTM).

In some embodiments, the polyolefin resin composition may have an adhesive strength of about 8 kgf/cm² to about 15 kgf/cm², for example, about 9 kgf/cm² to about 13 kgf/cm², as measured on a specimen through a procedure, in which the specimen is prepared by forming a bilayer film composed of a layer of the polyolefin resin composition and a layer of a polypropylene resin using a multilayer film forming machine, and attaching the bilayer film to a nylon-attached aluminum film with the layer of the polyolefin resin composition adjoining the aluminum film, followed by heating to 200° C. for 5 minutes, and in which measurement of the adhesive strength is performed by cutting the specimen to a size of 100 mm length, 25 mm width, dipping the specimen in an electrolyte for lithium secondary batteries at 85° C. for 24 hours, cutting both sides of the specimen to prepare a test piece having a length of 100 mm and a width of 15 mm, and peeling the layer of the polypropylene resin off of the aluminum film at a rate of 50 mm/min using a universal testing machine (UTM).

A molded article according to the present invention is formed of the polyolefin resin composition set forth above. The polyolefin resin composition may be prepared in pellet form. The prepared pellets may be produced into various molded articles (products) by various molding methods, such as injection molding, extrusion, vacuum molding, casting, and the like. Such molding methods are well known to a person having ordinary skill in the art to which the present invention pertains. The molded article is useful as an adhesive film, adhesive sheet, and the like for adhesion to polar substrates (aluminum, steel, ethylene vinyl alcohol (EVOH), polyamide, and the like) due to good properties thereof in terms of adhesive strength to polar substrates, electrolyte resistance, and the like.

### MODE FOR INVENTION

Next, the present invention will be described in more detail with reference to some examples. It should be understood that these examples are provided for illustration only and are not to be construed in any way as limiting the invention.

### EXAMPLE

Details of components used in Examples and Comparative Examples are as follows:

### (A) Base Material

(A1) A polypropylene copolymer resin (propylene-ethylene-1-butene terpolymer, melting point (Tm): about 132° C., product name: SFC-750, manufacturer: Lotte Chemical) was used.

(A2-1) A polyethylene resin (linear low-density polyethylene (LLDPE), product name: UT-404, manufacturer: Lotte Chemical) was used.

(A2-2) A polyethylene resin (low-density polyethylene (LDPE), product name: XL-610S, manufacturer: Lotte Chemical) was used.

### (A3) Polyolefin Elastomer

Ethylene-propylene rubber (product name: Vistalon 722, manufacturer: ExxonMobil) was used.

### (B) Maleic Anhydride-Modified Polypropylene Resin

### (B1) First Maleic Anhydride-Modified Polyolefin

A maleic anhydride-modified polypropylene (maleic anhydride graft ratio: about 2 wt %, weight average molecular weight: about 53,000 g/mol) was used.

### (B2) Second Maleic Anhydride-Modified Polyolefin

(B2-1) A maleic anhydride-modified polypropylene (maleic anhydride graft ratio: about 4 wt %, weight average molecular weight: about 19,000 g/mol) was used.

(B2-2) A maleic anhydride-modified polypropylene (maleic anhydride graft ratio: about 3 wt %, weight average molecular weight: about 38,000 g/mol) was used.

### Examples 1 to 8 and Comparative Examples 1 to 5

The aforementioned components were mixed in amounts as listed in Tables 1 and 2, followed by extrusion at a barrel temperature of about 170° C., thereby preparing a polyolefin resin composition in pellet form. Here, extrusion was performed using a twin-screw extruder (L/D: 40, diameter: 19 mm). The prepared pellets were dried at 80° C. for 4 hours or more and then prepared into specimens using a multilayer film forming machine according to property evaluation methods described below. The prepared specimens were evaluated as to the following properties. Results are shown in Tables 1 and 2.

### Property Evaluation

(1) Adhesive strength (peel strength, unit: kgf/cm²): Adhesive strength was measured on a specimen through a procedure, in which the specimen was prepared by forming a bilayer film composed of a layer of the polyolefin resin composition and a layer of a polypropylene resin (product name: SFC550, manufacturer: Lotte Chemical) using a multilayer film forming machine, and attaching the film onto a nylon-attached aluminum film (thickness: about 113 μm) with the layer of the polyolefin resin composition adjoining the aluminum film, followed by heating to 200° C. for 5 minutes, and in which measurement of the adhesive strength was performed by cutting the specimen to a size of 100 mm length, 15 mm width and peeling the layer of the polypropylene resin off of the aluminum film at a rate of 50 mm/min using a universal testing machine (UTM) (model name: Z020, manufacturer: ZwickRoell).

(2) Adhesive strength after dipping in electrolyte (electrolyte resistance, peel strength, unit: kgf/cm²): Adhesive strength was measured on a specimen through a procedure, in which the specimen was prepared by forming a bilayer film composed of a layer of the polyolefin resin composition and a layer of a polypropylene resin (product name: SFC550, manufacturer: Lotte Chemical) using a multilayer film forming machine, and attaching the film to a nylon-attached aluminum film (thickness: about 113 μm) with the layer of the polyolefin resin composition adjoining the aluminum film, followed by heating to 200° C. for 5 minutes, and in which measurement of the adhesive strength was performed by cutting the specimen to a size of 100 mm length, 15 mm width, dipping the specimen in an electrolyte for lithium secondary batteries at 85° C. for 24 hours, the electrolyte being a solution in which a lithium salt (LiPF₆) was dissolved at a concentration of 1 M in a solvent mixture of ethylene carbonate (EC), dimethyl carbonate (DMC), and diethyl carbonate (DEC) (volume ratio: 1:1:1), cutting both sides of the specimen to prepare a test piece having a length of 100 mm and a width of 15 mm, and peeling the layer of the polypropylene resin off of the aluminum film at a rate of 50 mm/min using a universal testing machine (UTM) (model name: Z020, manufacturer: ZwickRoell).

TABLE 1

| | | Example | | | | | | | |
|---|---|---|---|---|---|---|---|---|---|
| | | 1 | 2 | 3 | 4 | 5 | 6 | 7 | 8 |
| (A) (wt %) | (A1) | 85 | 80 | 80 | 80 | 80 | 80 | 75 | 80 |
| | (A2-1) | 5 | 10 | 10 | 10 | 10 | 10 | 10 | — |
| | (A2-2) | — | — | — | — | — | — | — | 10 |
| | (A3) | 10 | 10 | 10 | 10 | 10 | 10 | 15 | 10 |
| (B) (parts by weight) | | 5.5 | 5.5 | 5.5 | 7.5 | 6.0 | 6.0 | 5.5 | 5.5 |
| (B) (wt %) | (B1) | 90.9 | 90.9 | 90.9 | 93.3 | 83.3 | 66.7 | 90.9 | 90.9 |
| | (B2-1) | 9.1 | 9.1 | — | 6.7 | 16.7 | 33.3 | 9.1 | 9.1 |
| | (B2-2) | — | — | 9.1 | — | — | — | — | — |

| | | | | | | | | |
|---|---|---|---|---|---|---|---|---|
| Adhesive strength | 15.1 | 16.4 | 17.2 | 17.0 | 16.8 | 17.5 | 18.5 | 15.5 |
| Adhesive strength after | 9.8 | 10.2 | 9.9 | 11.5 | 11.5 | 10.7 | 11.3 | 12.1 |
| dipping in electrolyte | | | | | | | | |

*Parts by weight relative to 100 parts by weight of (A) base material

TABLE 2

| | | Comparative Example | | | | |
|---|---|---|---|---|---|---|
| | | 1 | 2 | 3 | 4 | 5 |
| (A) (wt %) | (A1) | 90 | 90 | 80 | 80 | 80 |
| | (A2-1) | — | 10 | 10 | 10 | 10 |
| | (A2-2) | — | — | — | — | — |
| | (A3) | 10 | | 10 | 10 | 10 |
| (B) (parts by weight) | | 5.5 | 5.5 | 5.5 | 5.0 | 6.0 |
| (B) | (B1) | 90.9 | 90.9 | — | 100 | 16.7 |
| (wt %) | (B2-1) | 9.1 | 9.1 | 9.1 | — | 83.3 |
| | (B2-2) | — | — | 90.9 | — | — |

| | | | | | |
|---|---|---|---|---|---|
| Adhesive strength | 13.6 | 8.7 | 7.5 | 14.8 | 8.7 |
| Adhesive strength after | 4.4 | 1.5 | 1.2 | 7.1 | 3.6 |
| dipping in electrolyte | | | | | |

*Parts by weight relative to 100 parts by weight of (A) base material

From the above results, it can be seen that the polyolefin resin compositions according to the present invention exhibited good properties in terms of adhesive strength to polar substrates, electrolyte resistance, and the like.

Conversely, it can be seen that the polyolefin resin composition prepared in Comparative Example 1, in which the polyethylene resin was not used (that is, the content of the polyethylene resin was less than the range according to the present invention), the polyolefin resin composition prepared in Comparative Example 2, in which the polyolefin elastomer was not used, (that is, the content of the polyolefin elastomer was less than the range according to the present invention), the polyolefin resin composition prepared in Comparative Example 3, in which the first maleic anhydride-modified polypropylene was not used, (that is, the weight average molecular weight of the first maleic anhydride-modified polypropylene was less than the range according to the present invention), the polyolefin resin composition prepared in Comparative Example 4, in which the second maleic anhydride-modified polypropylene was not used (that is, the weight average molecular weight of the second maleic anhydride-modified polypropylene exceeded the range according to the present invention), and the polyolefin resin composition prepared in Comparative Example 5, in which the content of the first maleic anhydride-modified polypropylene was less than the range according to the present invention and the content of the second maleic anhydride-modified polypropylene exceeded the range according to the present invention, all exhibited poor properties in terms of adhesive strength to polar substrates, electrolyte resistance, and the like.

Although some embodiments have been described herein, it will be understood by those skilled in the art that various modifications, changes, and alterations can be made without departing from the spirit and scope of the invention. Therefore, it should be understood that these embodiments are provided for illustration only and are not to be construed in any way as limiting the present invention. The scope of the present invention should be defined by the appended claims rather than by the foregoing description, and the claims and equivalents thereto are intended to cover such modifications and the like as would fall within the scope of the present invention.

1. A polyolefin resin composition comprising:
about 100 parts by weight of a base material comprising about 60 wt % to about 98 wt % of a polypropylene copolymer resin, about 1 wt % to about 30 wt % of a polyethylene resin, and about 1 wt % to about 30 wt % of a polyolefin elastomer; and
about 3 parts by weight to about 15 parts by weight of a maleic anhydride-modified polypropylene resin comprising about 50 wt % to about 95 wt % of a first maleic anhydride-modified polypropylene having a weight average molecular weight of about 40,000 g/mol or more and a maleic anhydride graft ratio of about 1.5 wt % or more and about 5 wt % to about 50 wt % of a second maleic anhydride-modified polypropylene having a weight average molecular weight of less than about 40,000 g/mol and a maleic anhydride graft ratio of about 1.5 wt % or more.

2. The polyolefin resin composition according to claim 1, wherein the polypropylene copolymer resin comprises at least one of a propylene/ethylene random copolymer and a propylene/ethylene/α-olefin copolymer.

3. The polyolefin resin composition according to claim 1, wherein the polypropylene copolymer resin comprises about 85 mol % to about 99 mol % of a propylene-derived component, about 1 mol % to about 10 mol % of an ethylene-derived component, and about 0 mol % to about 8 mol % of an α-olefin-derived component.

4. The polyolefin resin composition according to claim 1, wherein the polypropylene copolymer resin has a melting point (Tm) of about 120° C. to about 150° C.

5. The polyolefin resin composition according to claim 1, wherein the polyethylene resin comprises at least one of low-density polyethylene (LDPE), medium-density polyethylene (MDPE), high-density polyethylene (HDPE), and linear low-density polyethylene (LLDPE).

6. The polyolefin resin composition according to claim 1, wherein the polyethylene resin comprises at least one of low-density polyethylene (LDPE) and linear low-density polyethylene (LLDPE).

7. The polyolefin resin composition according to claim 1, wherein the polyolefin elastomer comprises at least one of ethylene-propylene rubber, ethylene-butene rubber, and ethylene-octene rubber.

8. The polyolefin resin composition according to claim 1, wherein the first maleic anhydride-modified polypropylene has a weight average molecular weight of about 45,000 g/mol to about 60,000 g/mol and a maleic anhydride graft ratio of about 1.6 wt % to about 6 wt %.

9. The polyolefin resin composition according to claim 1, wherein the second maleic anhydride-modified polypropylene has a weight average molecular weight of about 10,000 g/mol to about 39,000 g/mol and a maleic anhydride graft ratio of about 1.6 wt % to about 6 wt %.

10. The polyolefin resin composition according to claim 1, wherein a weight ratio of the first maleic anhydride-modified polypropylene to the second maleic anhydride-modified polypropylene ranges from about 1:0.06 to about 1:0.7.

11. The polyolefin resin composition according to claim 1, wherein the polyolefin resin composition has an adhesive strength of about 15 kgf/cm² to about 20 kgf/cm², as measured on a specimen through a procedure, in which the specimen is prepared by forming a bilayer film composed of a layer of the polyolefin resin composition and a layer of a polypropylene resin using a multilayer film forming machine, and attaching the bilayer film to a nylon-attached aluminum film with the layer of the polyolefin resin composition adjoining the aluminum film, followed by heating to 200° C. for 5 minutes, and in which measurement of the adhesive strength is performed by cutting the specimen to a size of 100 mm length, 15 mm width and peeling the layer of the polypropylene resin off of the aluminum film at a rate of 50 mm/min using a universal testing machine (UTM).

12. The polyolefin resin composition according to claim 1, wherein the polyolefin resin composition has an adhesive strength of about 8 kgf/cm² to about 15 kgf/cm², as measured on a specimen through a procedure, in which the specimen is prepared by forming a bilayer film composed of a layer of the polyolefin resin composition and a layer of a polypropylene resin using a multilayer film forming machine, and attaching the bilayer film to a nylon-attached aluminum film with the layer of the polyolefin resin composition adjoining the aluminum film, followed by heating to 200° C. for 5 minutes, and in which measurement of the adhesive strength is performed by cutting the specimen to a size of 100 mm length, 25 mm width, dipping the specimen in an electrolyte for lithium secondary batteries at 85° C. for 24 hours, cutting both sides of the specimen to prepare a test piece having a length of 100 mm and a width of 15 mm, and peeling the layer of the polypropylene resin off of the aluminum film at a rate of 50 mm/min using a universal testing machine (UTM).

13. A molded article formed of the polyolefin resin composition according to claim 1.
